(19) United States
(12) Patent Application Publication
(10) Pub. No.: US 2017/0225628 A1
(43) Pub. Date: Aug. 10, 2017

(54) Motorized Camera Mount

(71) Applicant: Ford Global Technologies, LLC, Dearborn, MI (US)

(72) Inventors: Sudipto Aich, Palo Alto, CA (US); Chih-Wei Tang, Mountain View, CA (US)

(21) Appl. No.: 15/019,720

(22) Filed: Feb. 9, 2016

(51) Int. Cl. B60R 11/04; G01C 21/34; H04N 5/44; H04N 5/225; B60R 1/00

(52) U.S. Cl. CPC B60R 11/04; H04N 5/2251; B60R 1/00; H04N 5/44; G01C 21/34

(57) ABSTRACT

Example motorized camera mounts are described. In one implementation, an apparatus for mounting a camera to a vehicle includes a motor and a rotatable shaft operatively coupled to the motor. The rotatable shaft includes a mechanism for mounting a camera. A controller is coupled to the motor and configured to control rotation of the rotatable shaft based on a desired orientation of the camera.

### TECHNICAL FIELD

The present disclosure relates to systems and methods that rotate a camera which is detachably mounted to a rear-view mirror of a vehicle.

### BACKGROUND

Many individuals enjoy capturing images and recording video while driving a vehicle, such as a car, truck, motorcycle or bicycle. For example, drivers may record the view out the front windshield of a car while driving along a scenic road. Others may record a view while driving their car or motorcycle during a race or other performance event. Existing systems attach cameras, smartphones, and other image capture devices to a vehicle in a fixed position (e.g., capturing images directly in front of the vehicle). For example, certain existing systems use a suction mount to attach a camera to the vehicle's windshield. This type of mounting system holds the camera in a fixed position, which supports the recording of only one angle or viewpoint. A dangerous situation occurs if a vehicle driver attempts to manually reposition the camera while actively driving the vehicle.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIGS. 1A and 1B depict an embodiment of a motorized camera mount and a camera capable of being attached to the motorized camera mount. FIG. 1A illustrates a mounted camera and FIG. 1B illustrates various components prior to mounting the camera.

FIG. 2 depicts an embodiment of a motorized camera mount contained in a vehicle side-view mirror.

FIG. 3 is a block diagram depicting example components of a motorized camera mount as well as vehicle systems and a mobile device capable of communicating with the components of the motorized camera mount.

FIG. 4 is a block diagram depicting an embodiment of a controller.

FIG. 5 is a flow diagram depicting an embodiment of a method for rotating a motor associated with the motorized camera mount.

FIG. 6 is a flow diagram depicting an embodiment of a method for controlling the motorized camera mount with a mobile device.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

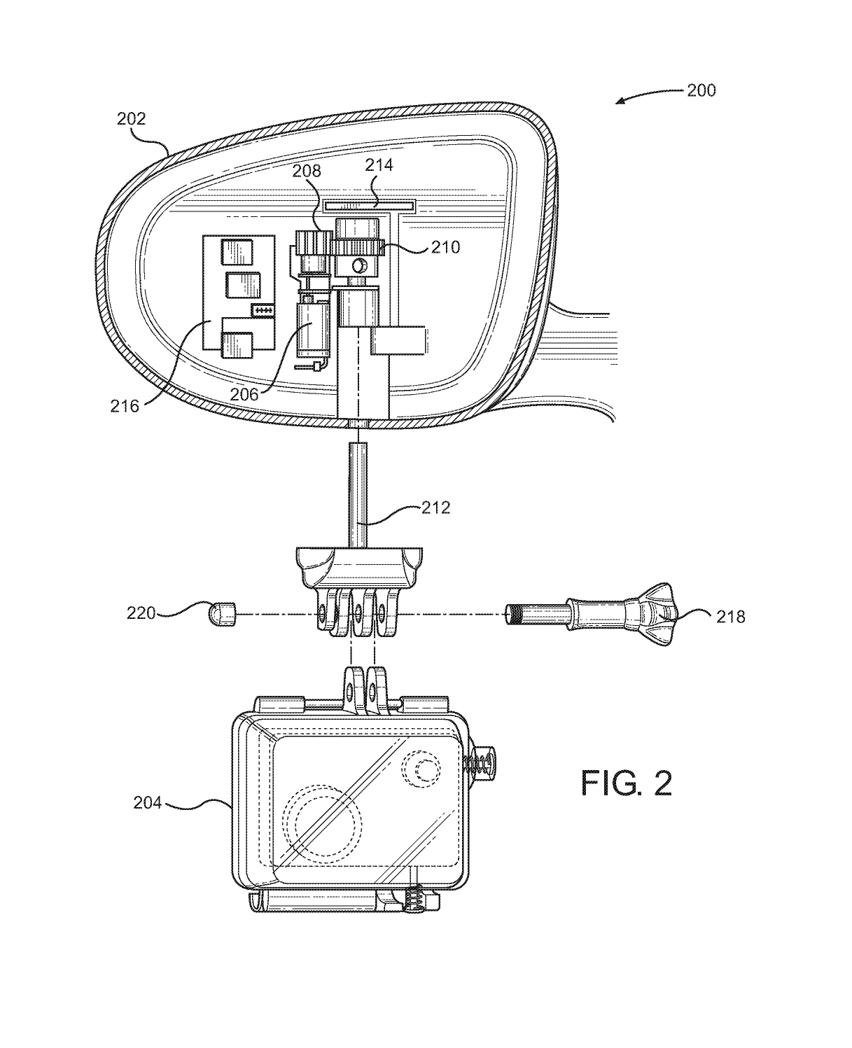

Specific embodiments discussed herein are related to a rear-view mirror in a vehicle. These embodiments are provided for the purpose of discussing various aspects of the invention. However, alternate embodiments of the invention can be incorporated into other vehicle mirrors and other vehicle components. For example, the systems and methods described herein may be implemented in a vehicle visor, an overhead console (or other overhead component), a dashboard, and the like. Additionally, the described systems and methods can be incorporated into other parts of the vehicle, such as side-view mirrors (see FIG. 2) and other components located inside or outside of the vehicle.

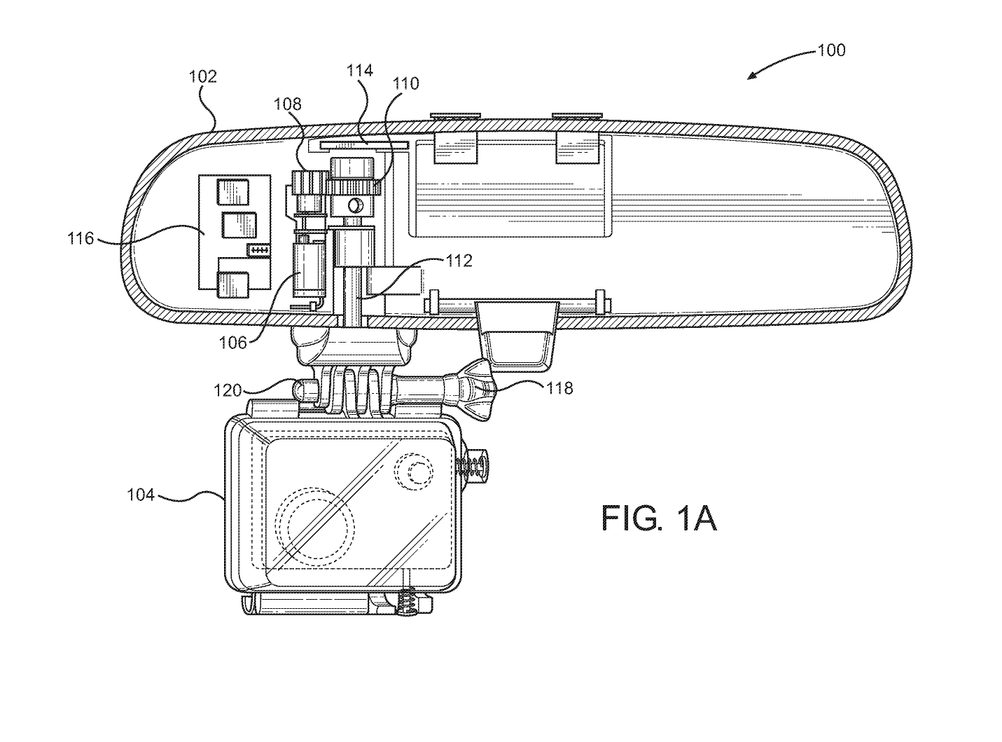

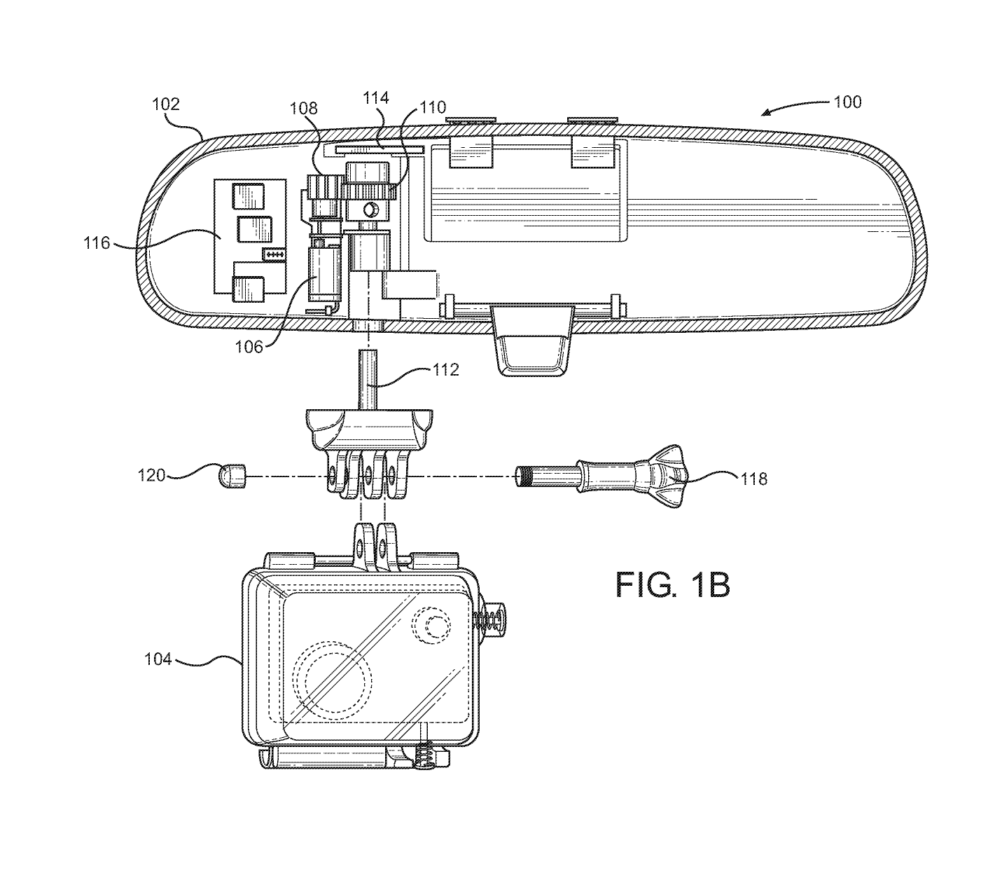

FIGS. 1A and 1B depict an embodiment 100 of a motorized camera mount and a camera capable of being attached to the motorized camera mount. FIG. 1A illustrates a mounted camera and FIG. 1B illustrates various components prior to mounting the camera. FIGS. 1A and 1B illustrate a rear-view mirror 102 capable of being attached, for example, to the interior surface of a vehicle windshield. In FIGS. 1A and 1B, the back of rear-view mirror 102 is shown. The opposite side of rear-view mirror 102 contains a mirror used by the driver of the vehicle. Rear-view mirror 102 includes a housing that surrounds at least a significant portion of the back of rear-view mirror 102. In the example of FIGS. 1A and 1B, the rear housing of rear-view mirror 102 is not shown to enable illustration of various components contained within the housing of rear-view mirror 102.

A camera 104 is removably mounted to rear-view mirror 102, as discussed herein. A motor 106 is located within rear-view mirror 102. Motor 106 includes a shaft with an attached gear 108, which engages a second gear 110 on a second shaft 112. A sensor 114 is positioned near an end of second shaft 112 and senses the position and movement (i.e., rotation) of second shaft 112. In some embodiments, sensor 114 is a magnetic sensor that senses the position and movement of magnetic elements attached to (or disposed on) an end of second shaft 112. In other embodiments, sensor 114 may be an optical sensor or any other sensing device capable of detecting the position and movement of second shaft 112.

Rear-view mirror 102 also includes a controller 116 that controls the operation of motor 106, such as the rotation direction of motor 106 and the rotational speed of motor 106. As discussed herein, controller 116 may control the operation of motor 106 based on predetermined operational settings, data received from a vehicle navigation system, information received from a vehicle infotainment system or data received from a mobile device. In some embodiments, controller 116 is coupled to motor 106 and one or more vehicle systems, such as navigation systems and infotainment systems. In a particular implementation, controller 116 is coupled to the vehicle's CAN (Controller Area Network) bus to facilitate communication between controller 116 and other devices coupled to the CAN bus. Additionally, controller 116 and motor 106 may receive electrical power from a vehicle circuit that distributes power to rear-view mirror 102. Power may also be distributed from rear-view mirror 102 to camera 104, thereby enabling the recharging of one or more batteries in camera 104 when it is attached to rear-view mirror 102. In a particular implementation, a wire or other conductor is routed through an opening running through second shaft 112 to provide power from rear-view mirror 102 to camera 104.

Rear-view mirror 102 also includes a pin 118 used to mount camera 104 to rear-view mirror 102. In some embodiments, pin 118 is inserted through a mounting structure attached to camera 104 and through an aperture in second shaft 112. In other embodiments, pin 118 is inserted through a mounting structure attached to camera 104 and through a corresponding mounting structure attached to second shaft 112. In these embodiments, second shaft 112 passes through an opening of rear-view mirror 102 housing and extends below rear-view mirror 102 to allow mounting of camera 104. A nut or cap 120 is optionally attached to the end of pin 118 (e.g., by twisting nut or cap 120 onto the end of pin 118) to prevent pin 118 from sliding out of the mounting components. In alternate embodiments, any type of mounting mechanism may be used to secure camera 104 to second shaft 112, such as clips, screws, clamps, adhesive, and the like. One or more of these alternate embodiments may include a mounting structure attached to (or disposed on) second shaft 112, where the mounting structure engages a corresponding mounting structure on camera 104.

In operation, controller 116 sends control signals to motor 106, which instruct motor 106 to rotate in a particular direction and at a particular speed. As motor 106 rotates gear 108, the corresponding gear 110 (which mechanically engages gear 108) causes second shaft 112 to rotate. Camera 104 is attached to second shaft 112. Thus, as second shaft 112 rotates, camera 104 rotates in the same direction and at the same speed as second shaft 112. Controller 116 receives feedback from sensor 114 regarding the position and speed of second shaft 112. Based on this received feedback, controller 116 may adjust the rotational direction and/or speed of second shaft 112 to maintain camera 104 in a desired orientation.

Although a particular embodiment is shown in FIGS. 1A and 1B, alternate embodiments may accomplish similar results with different arrangements of components. For example, some embodiments may eliminate second shaft 112 by having motor 106 positioned such that the shaft of motor 106 extends from the bottom of rear-view mirror 102.

In some embodiments, when camera 104 is coupled to rear-view mirror 102 in a manner that is offset from the middle of rear-view mirror 102 (as shown in FIGS. 1A and 1B), the additional weight of camera 104 may cause rear-view mirror 102 to gradually tilt downward on the side with camera 104. To avoid this possible downward tilt, and subsequent adjustments by the driver to straighten rear-view mirror 102, additional weight may be added in the opposite side of rear-view mirror 102 to act as a counterweight. Additionally, certain components of rear-view mirror 102 may be located in the opposite side of rear-view mirror 102 to help balance the weight on opposite sides of the rear-view mirror.

As discussed in greater detail below, some embodiments of controller 116 may receive vehicle data, such as vehicle speed, vehicle location, vehicle orientation, steering angle, rotational speed of the steering wheel, lateral acceleration, and yaw rate of the vehicle. The vehicle data may be provided by one or more sensors and/or vehicle control systems associated with the vehicle, such as speed sensors, steering angle sensors, yaw sensors, acceleration sensors, gyros, GPS (global positioning system) modules, and the like. Vehicle data is communicated to controller 116 using any communication medium (e.g., wired or wireless) and any communication protocol. In some embodiments, vehicle data is received by controller 116 on a continuous basis such that the vehicle data is substantially real-time data. In other embodiments, controller 116 receives vehicle data at regular intervals (e.g., every 500 milliseconds or every second). This vehicle data is used to generate control instructions that determine whether to operate motor 106 and, if operation is needed, determine the rotation direction and rotation speed to operate the motor. For example, if the turning angle of the vehicle changes, motor 106 may need adjustment to reposition camera 104 such that camera 104 can continue to capture images or record video in a particular orientation.

A particular mounting system is shown in FIGS. 1A and 1B for mounting camera 104 to second shaft 112 for purposes of explanation. However, any type of mounting system can be used to attach camera 104 to second shaft 112. Alternate mounting systems may eliminate pin 118 or use a different type of pin or other fastening mechanism. For example, alternate mounting systems may include a screw-type camera mount commonly used on camera tripods and other structures. Other mounting systems may use a clip or snap-type mounting system.

The embodiment shown in FIGS. 1A and 1B illustrates second shaft 112 extending through the bottom of rear-view mirror 102. In other embodiments, second shaft 112 extends through a side of rear-view mirror 102, or through the side of another vehicle component containing motor 106, controller 116, and other devices discussed herein. In these embodiments, one or more bevel gears, or similar mechanisms, are used to mechanically couple a shaft coupled to motor 106 with camera 104 or part of the mounting mechanism that mounts camera 104 to the shaft. In other embodiments, second shaft 112 extends through the top of rear-view mirror 102, or through the top of any other vehicle component containing motor 106, controller 116, and other devices discussed herein.

FIG. 2 depicts an embodiment 200 of a motorized camera mount contained in a vehicle side-view mirror 202. The components of FIG. 2 are similar to those discussed above with respect to FIGS. 1A and 1B. The significant difference in FIG. 2 is providing the motorized camera mount within a side-view mirror instead of a rear-view mirror. In particular, a housing surrounds at least a significant portion of side-view mirror 202. In the example of FIG. 2, a portion of the housing of side-view mirror 202 is not shown to enable illustration of various components contained within the housing of side-view mirror 202.

A camera 204 is removably mounted to side-view mirror 202, as discussed herein. A motor 206 is located within side-view mirror 202. Motor 206 includes a shaft with an attached gear 208, which engages a second gear 210 on a second shaft 212. A sensor 214 is positioned near an end of second shaft 212 and senses the position and movement (i.e., rotation) of second shaft 212. In some embodiments, sensor 214 is a magnetic sensor that senses the position and movement of magnetic elements attached to (or disposed on) an end of second shaft 212. In other embodiments, sensor 214 may be an optical sensor or any other sensing device capable of detecting the position and movement of second shaft 212.

Side-view mirror 202 also includes a controller 216 that controls the operation of motor 206, such as the rotation direction of motor 206 and the rotational speed of motor 206. As discussed herein, controller 216 may control the operation of motor 206 based on predetermined operational settings, data received from a vehicle navigation system, information received from a vehicle infotainment system or data received from a mobile device. In some embodiments, controller 216 is coupled to motor 206 and one or more vehicle systems, such as navigation systems and infotainment systems. In a particular implementation, controller 216 is coupled to the vehicle's CAN (Controller Area Network) bus to facilitate communication between controller 216 and other devices coupled to the CAN bus. Additionally, controller 216 and motor 206 may receive electrical power from a vehicle circuit that distributes power to side-view mirror 202. Power may also be distributed from side-view mirror 202 to camera 204, thereby enabling the recharging of one or more batteries in camera 204 when it is attached to side-view mirror 202. In a particular implementation, a wire or other conductor is routed through an opening running through second shaft 212 to provide power from side-view mirror 202 to camera 204.

Side-view mirror 202 also includes a pin 218 used to mount camera 204 to side-view mirror 202. In some embodiments, pin 218 is inserted through a mounting structure attached to camera 204 and through an aperture in second shaft 212. In other embodiments, pin 218 is inserted through a mounting structure attached to camera 204 and through a corresponding mounting structure attached to second shaft 212. In these embodiments, second shaft 212 passes through an opening of side-view mirror 202 housing and extends below side-view mirror 202 to allow mounting of camera 204. A nut or cap 220 is optionally attached to the end of pin 218 (e.g., by twisting nut or cap 220 onto the end of pin 218) to prevent pin 218 from sliding out of the mounting components. In alternate embodiments, any type of mounting mechanism may be used to secure camera 204 to second shaft 212, such as clips, screws, clamps, adhesive, and the like. One or more of these alternate embodiments may include a mounting structure attached to (or disposed on) second shaft 212, where the mounting structure engages a corresponding mounting structure on camera 204.

In operation, controller 216 sends control signals to motor 206, which instruct motor 206 to rotate in a particular direction and at a particular speed. As motor 206 rotates gear 208, the corresponding gear 210 (which mechanically engages gear 208) causes second shaft 212 to rotate. Camera 204 is attached to second shaft 212. Thus, as second shaft 212 rotates, camera 204 rotates in the same direction and at the same speed as second shaft 212. Controller 216 receives feedback from sensor 214 regarding the position and speed of second shaft 212. Based on this received feedback, controller 216 may adjust the rotational direction and/or speed of second shaft 212 to maintain camera 204 in a desired orientation.

Although a particular embodiment is shown in FIG. 2, alternate embodiments may accomplish similar results with different arrangements of components. For example, some embodiments may eliminate second shaft 212 by having motor 206 positioned such that the shaft of motor 206 extends from the bottom of side-view mirror 202.

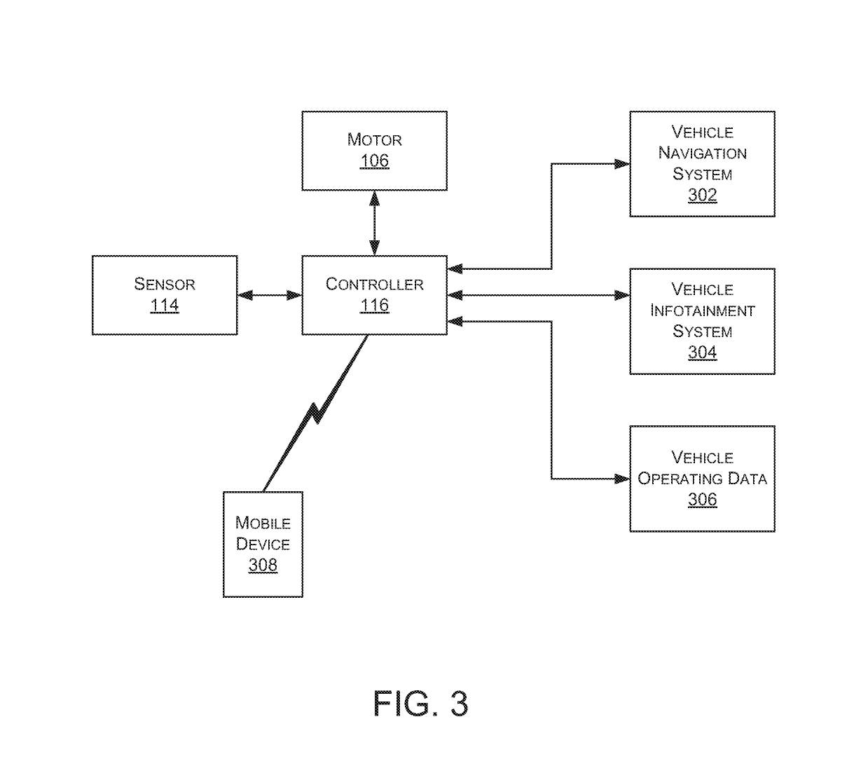

FIG. 3 is a block diagram depicting example components of a motorized camera mount as well as vehicle systems and a mobile device capable of communicating with the components of the motorized camera mount. In particular, FIG. 3 illustrates motor 106, sensor 114 and controller 116 as discussed above with respect to FIGS. 1A and 1B. Additionally, a vehicle navigation system 302, a vehicle infotainment system 304, and a source of vehicle operating data 306 are coupled to controller 116. As mentioned herein, controller 116 may communicate with one or more of vehicle navigation system 302, vehicle infotainment system 306 and the source of vehicle operating data 306 via a CAN bus. Vehicle navigation system 302 may include a global positioning system (GPS), map data and other information and components used to navigate a vehicle. In some embodiments, vehicle navigation system 302 determines upcoming route information and communicates the route information to controller 116. Controller 116 uses the upcoming route information to determine a desired orientation of a camera controlled by motor 106 and, if necessary to achieve the desired orientation, instructs motor 106 to rotate in a manner that positions the camera in the desired orientation. In other embodiments, vehicle navigation system 302 determines a desired camera orientation based on the upcoming route information and communicates the desired camera orientation to controller 116, thereby allowing controller 116 to position the camera appropriately by sending operating instructions to motor 106.

In some embodiments, vehicle infotainment system 304 may communicate information to controller 116 regarding the desired orientation of the camera controlled by motor 106. For example, a user (e.g., a vehicle driver or passenger) may identify desired camera orientations through a user interface of vehicle infotainment system 304. These desired orientations are communicated to controller 116, which issues appropriate operating instructions to motor 106 at the proper times.

In some embodiments, vehicle operating data 306 is communicated to controller 116, which uses the data to determine an appropriate camera orientation. As mentioned above, the vehicle operating data may include, for example, vehicle speed, vehicle location, vehicle orientation, steering angle, rotational speed of the steering wheel, lateral acceleration, and yaw rate of the vehicle. Sources of vehicle operating data 306 include, for example, one or more sensors and/or vehicle control systems associated with the vehicle, such as speed sensors, steering angle sensors, yaw sensors, acceleration sensors, gyros, GPS (global positioning system) modules, and the like.

In some embodiments, a mobile device 308 is coupled to controller 116. Mobile device 308 is operated by a user in the vehicle, outside the vehicle, or in a remote location (i.e., a significant distance from the vehicle). Mobile device 308 includes a user interface that allows a user to control the camera's orientation. For example, the user may set a particular camera orientation for a current driving activity, or pre-set a camera orientation (or a range of camera orientations) for a future driving activity. Mobile device 308 communicates with controller 116 via one or more wireless communication links and/or networks. In some embodiments, mobile device 308 communicates with controller 116 using Bluetooth Low Energy (BLE) network technology.

Although multiple separate components are shown in FIG. 3, particular implementations may combine multiple components together. For example, vehicle navigation system 302 may be combined with vehicle infotainment system 304.

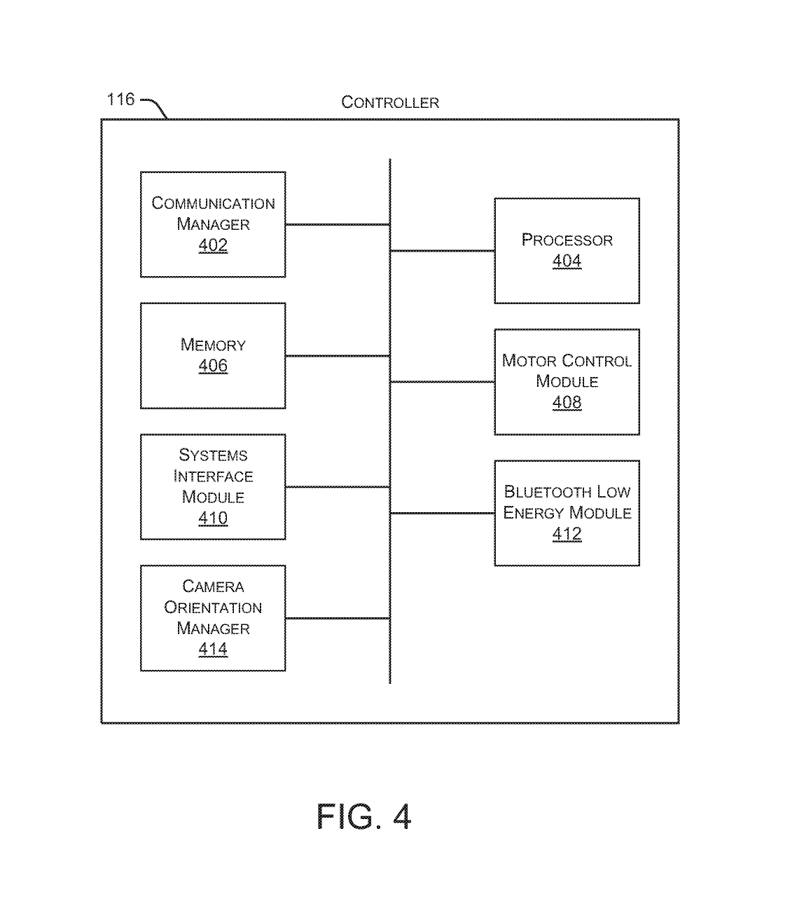

FIG. 4 is a block diagram depicting an embodiment of controller 116. As shown in FIG. 4, controller 116 includes a communication manager 402, a processor 404, and a memory 406. Communication manager 402 allows controller 116 to communicate with other systems, such as motor 106, sensor 114, vehicle navigation system 302, vehicle infotainment system 304, sources of vehicle operating data 306, and mobile device 308. Processor 404 executes various instructions to implement the functionality provided by controller 116. Memory 406 stores these instructions as well as other data used by processor 404 and other modules contained in controller 116.

Additionally, controller 116 includes a motor control module 408 that sends signals or commands to motor 106 that instruct the motor to rotate a particular direction, at a particular speed, and until a desired orientation is reached. Motor control module 408 may also receive motor position information from sensor 114. A systems interface module 410 manages various interface components and interface protocols between controller 116 (via communication manager 402) and other systems, such as motor 106, sensor 114, vehicle navigation system 302, vehicle infotainment system 304, sources of vehicle operating data 306, and mobile device 308. Controller 116 may include a Bluetooth Low Energy (BLE) module 412 to support BLE communications between controller 116 and other BLE devices, such as mobile device 308. In other embodiments, BLE module 412 may be replaced with other communication systems, such as WiFi, Bluetooth classic, XBee, wired communication systems, and the like. A camera orientation manager 414 assists with managing the proper orientation of the camera based on data received from various sources discussed herein. Camera orientation manager 414 may work in combination with processor 404 and motor control module 408 to determine necessary motor movements to maintain a desired camera orientation.

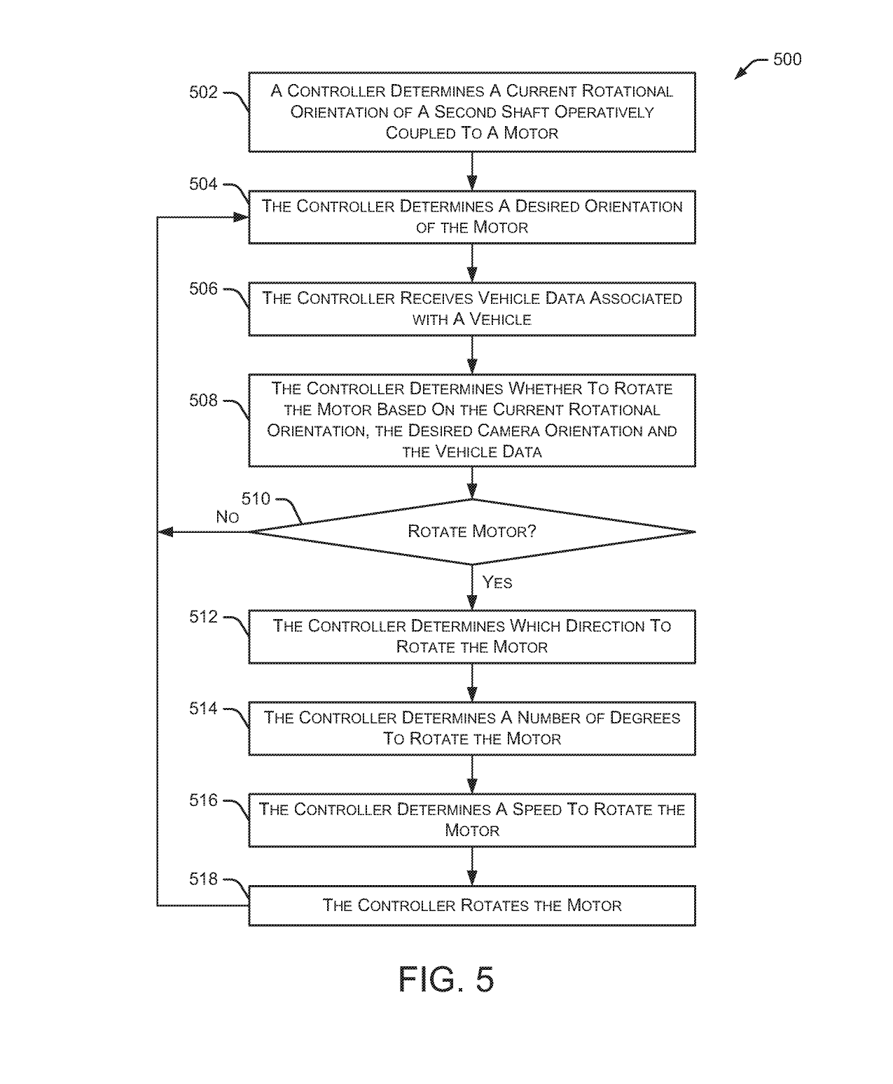

FIG. 5 is a flow diagram depicting an embodiment of a method 500 for rotating a motor associated with the motorized camera mount. Initially, controller 116 determines a current rotational orientation of second shaft 112 operatively coupled to motor 106 at 502. The current rotational orientation can be determined, for example, by sensor 114 or other system capable of determining the orientation of second shaft 112 or the orientation of camera 104 mounted to second shaft 112.

Method 500 continues as controller 116 determines a desired orientation of camera 104 at 504. The desired orientation is determined, for example, based on a user setting or a pre-defined range of orientations selected by a user. As discussed herein, the desired orientation of camera 104 can be determined based on upcoming route information from vehicle navigation system 302, information entered by a user into vehicle infotainment system 304, and vehicle operating data 306. In some embodiments, a user can select or define one or more ranges of orientations for camera 104.

Method 500 continues as controller 116 receives vehicle data associated with a vehicle at 506. Controller 116 determines, at 508, whether to rotate motor 106 based on the current rotational orientation of the motor/camera, the desired camera orientation and the received vehicle data. For example, if the current orientation of the motor/camera matches the desired orientation and the vehicle is not turning, motor 106 does not need to be rotated. In this situation, motor 106 is not rotated at 510 and the method returns to 504 where it continues monitoring changes in the received vehicle data.

If method 500 determines that motor 106 needs to be rotated at 510, controller 116 determines which direction to rotate motor 106 at 512. For example, motor 106 may be rotated in a clockwise direction or a counter-clockwise direction depending on the necessary orientation change to the motor/camera. Controller 116 also determines, at 514, a number of degrees to rotate motor 106. The amount of rotation depends, for example, on the magnitude of the orientation change necessary to rotate the motor/camera to the desired orientation. Additionally, controller 116 determines, at 516, a speed to rotate motor 106. The speed of rotation depends, for example, on the magnitude of the orientation change necessary as well as current vehicle data, such as a current vehicle speed and a current steering angle of the vehicle. Controller 116 sends appropriate signals to motor 106 at 518 that instruct motor 106 to rotate in a particular direction, for a specified number of degrees, at a particular speed based on the above determinations. After rotation of the motor/camera is complete, method 500 returns to 504 and continues monitoring changes in the received vehicle data.

In some embodiments, the rotation direction is determined based on the steering direction of the vehicle. For example, if the vehicle is turning to the left, the motor may rotate the camera to the left to maintain the desired orientation for the camera. In particular implementations, the method determines a new position for the camera and determines the rotation direction and number of degrees to rotate based on this new position. For example, the new position may be calculated by:

new position=x+d

where x=current_position−steering_wheel_angle

and “current_position” is the current position of the motor and “steering_wheel_angle” is the current angle of the steering wheel.

The value of “x” represents the number of degrees the motor should rotate based on, for example, information received from the sensor associated with the second shaft and the current steering wheel angle (received as part of the vehicle data). The value of “d” represents an offset that could be fixed (e.g., hard-coded) or changed through one or more user interface controls. The offset is used in determining whether to rotate the motor. For example, the motor should not be rotated if the difference between the current motor position and the steering wheel angle is equal to the offset value.

If the motor needs to be rotated, the speed at which to rotate the motor is determined may be based on the rotational speed of the steering wheel. In some embodiments, the motor rotation speed is based, at least in part, on the yaw rate of the vehicle as determined by a gyroscope, accelerometer or similar device in the vehicle. In particular implementations, the rotational speed of the motor is multiplied by a constant, k, to allow for a faster response time. For example, if w is the rotational speed of the motor based on the rotational speed of the steering wheel, the speed to rotate the motor (to its new position) is: w*k. Typically, there is a delay between when the steering wheel angle changes and when the motor actually starts to rotate. If the motor is always rotated at the same speed as the steering wheel, the motor (and the attached camera) will always lag behind. The constant k gives the motor an opportunity to “catch up” with or overtake the steering_wheel_angle.

In some embodiments, the described systems and methods determine whether the motor needs to be rotated (and, if needed, the rotation speed and number of degrees) based on an upcoming route determined by a navigation system.

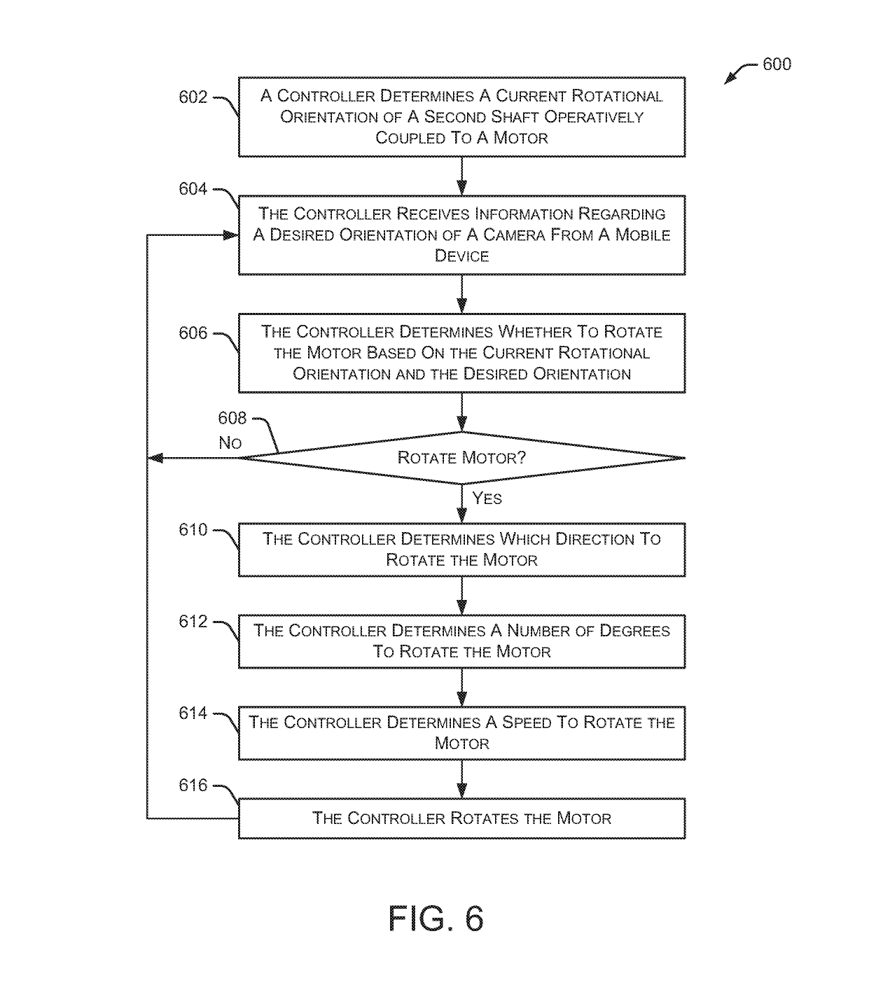

FIG. 6 is a flow diagram depicting an embodiment of a method 600 for controlling the motorized camera mount with a mobile device. Initially, controller 116 determines a current rotational orientation of second shaft 112 operatively coupled to motor 106 at 602. The current rotational orientation can be determined, for example, by sensor 114 or other system capable of determining the orientation of second shaft 112 or the orientation of camera 104 mounted to second shaft 112.

Method 600 continues as controller 116 receives information regarding a desired orientation of camera 104 from mobile device 208 at 604. Controller 116 then determines, at 606, whether to rotate motor 106 based on the current rotational orientation of the motor/camera and the desired camera orientation received from mobile device 308. For example, if the current orientation of the motor/camera matches the desired orientation, motor 106 does not need to be rotated. In this situation, motor 106 is not rotated at 608 and the method returns to 604 where it continues monitoring changes in the desired orientation of the camera.

If method 600 determines that motor 106 needs to be rotated at 608, controller 116 determines which direction to rotate motor 106 at 610. For example, motor 106 may be rotated in a clockwise direction or a counter-clockwise direction depending on the necessary orientation change to the motor/camera. Controller 116 also determines, at 612, a number of degrees to rotate motor 106. The amount of rotation depends, for example, on the magnitude of the orientation change necessary to rotate the motor/camera to the desired orientation. Additionally, controller 116 determines, at 614, a speed to rotate motor 106. The speed of rotation depends, for example, on the magnitude of the orientation change necessary. Controller 116 sends appropriate signals to motor 106 at 616 that instruct motor 106 to rotate in a particular direction, for a specified number of degrees, at a particular speed based on the above determinations. After rotation of the motor/camera is complete, method 600 returns to 604 and continues monitoring changes in the desired orientation of the camera.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. An apparatus for mounting a camera to a vehicle, the apparatus comprising:
a motor;
a rotatable shaft operatively coupled to the motor, wherein the rotatable shaft includes a mechanism for mounting a camera; and
a controller coupled to the motor and configured to control rotation of the rotatable shaft based on a desired orientation of the camera.

2. The apparatus of claim 1, wherein the controller is further coupled to an infotainment system in the vehicle, and wherein the infotainment system provides the desired orientation of the camera to the controller.

3. The apparatus of claim 1, wherein the controller is further coupled to a navigation system in the vehicle, and wherein the navigation system provides upcoming vehicle route information to the controller.

4. The apparatus of claim 1, wherein the controller is further coupled to a mobile device via a wireless communication link.

5. The apparatus of claim 4, wherein the mobile device communicates the desired orientation of the camera to the controller.

6. The apparatus of claim 1, wherein the controller is further configured to control rotation of the rotatable shaft based on at least one of a current steering angle of the vehicle, a current vehicle speed, a lateral acceleration, a steering wheel rotation speed, and a vehicle yaw rate.

7. The apparatus of claim 1, wherein the motor and the controller are contained within a rear-view mirror attached to the vehicle.

8. The apparatus of claim 1, wherein the motor and the controller are contained within a side-view mirror attached to the vehicle.

9. The apparatus of claim 1, further comprising a magnetic sensor proximate the rotatable shaft, the magnetic sensor configured to determine a current rotational orientation of the rotatable shaft.

10. The apparatus of claim 9, wherein the magnetic sensor is further configured to determine a current speed and direction of rotation of the rotatable shaft.

11. The apparatus of claim 10, wherein data associated with the current speed and direction of rotation of the rotatable shaft is communicated to the controller.

12. The apparatus of claim 1, wherein the controller is further configured to control the speed and direction at which the motor rotates the rotatable shaft based on a desired orientation of the camera.

13. The apparatus of claim 1, wherein the controller is further configured to control the speed or direction at which the motor rotates the rotatable shaft based on a desired orientation of the camera and at least one of a current steering angle of the vehicle, a current vehicle speed, a lateral acceleration, a steering wheel rotation speed, and a vehicle yaw rate.

14. A vehicle rear-view mirror comprising:
a motor having a first rotatable shaft;
a second rotatable shaft operably coupled to the first rotatable shaft, wherein the second rotatable shaft rotates responsive to rotation of the first rotatable shaft, and wherein the second rotatable shaft includes a mechanism for mounting a camera; and
a controller coupled to the motor and configured to control the speed and direction at which the motor rotates the first rotatable shaft.

15. The vehicle rear-view mirror of claim 1, wherein the controller is further coupled to a mobile device via a wireless communication link.

16. The vehicle rear-view mirror of claim 15, wherein the mobile device communicates camera orientation instructions to the controller.

17. The vehicle rear-view mirror of claim 1, wherein the controller is further configured to control the speed and direction at which the motor rotates the first rotatable shaft based on a desired orientation of the camera.

18. A method comprising:
receiving a current rotational orientation of a motor mounted to a vehicle;
receiving a desired orientation of a motor based on a desired orientation of a camera coupled to the motor;
determining, using one or more processors, whether to rotate the motor based on the desired orientation of the camera and the current rotational orientation of the motor;
responsive to determining to rotate the motor:
determining, using the one or more processors, a direction to rotate the motor;
determining, using the one or more processors, a speed to rotate the motor; and
generating, using the one or more processors, instructions to rotate the motor based on the direction and the speed to rotate the motor.

19. The method of claim 18, wherein receiving the desired orientation of the motor includes receiving upcoming vehicle route information from a vehicle navigation system.

20. The method of claim 18, wherein receiving the current rotational orientation of the motor includes receiving rotational orientation information from a sensor proximate the motor.
